(19) United States
(12) Patent Application Publication
(10) Pub. No.: US 2006/0265816 A1
(43) Pub. Date: Nov. 30, 2006

(54) Formers for spray dyeing garments

(76) Inventors: Michael Abbott, Statesville, NC (US); Robert Miller, New Ringgold, PA (US); Ruth May, Schuylkill Haven, PA (US); Martin Bentham, Barnsley (GB)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/392,322

(22) Filed: Mar. 29, 2006

Related U.S. Application Data
(63) Continuation-in-part of application No. 10/601,820, filed on Jun. 23, 2003, now Pat. No. 7,033,403.
(60) Provisional application No. 60/666,940, filed on Mar. 31, 2005.

(51) Int. Cl. C09B 67/00

(52) U.S. Cl. 8/401

(57) ABSTRACT

A former for spraying a garment with a dye is provided. The former includes a hollow frame having a plurality of individual elements configured to support the garment and a plurality of openings being defined between the plurality of individual elements so that the hollow frame has a thermal conductivity that is equal to or less than a thermal conductivity of the garment.

### CROSS REFERENCE TO RELATED APPLICATIONS

This application claims benefit of U.S. Provisional Application No. 60/666,940 filed on Mar. 31, 2005, the contents of which are incorporated by reference herein. This application is a continuation-in-part of U.S. application Ser. No. 10/601,820 entitled Spray Dyeing of Garments and filed on Jun. 23, 2003, the contents of which are incorporated by reference herein.

### BACKGROUND OF THE INVENTION

1. Field of the Invention

The present invention is related to fabric dyeing. More particularly, the present invention is related to formers used in for spray dyeing garments.

2. Description of Related Art

Today, fabrics are made from a wide-variety of natural fibers, synthetic fibers, and any combination thereof. Many methods have been proposed for dyeing fabrics.

One method, commonly referred to as yarn dyeing, involves dyeing individual fibers or yarns before the fibers are sewn or knitted into a fabric. One problem associated with such yarn dyeing method relates to inventory control of the yarns and associated garments. For example, yarn dyeing requires the garment manufacturer to maintain a supply of the various colored yarns used in its products. This can lead to an increased cost of goods.

Another dyeing method is commonly referred to as bulk dyeing. In bulk dyeing, un-dyed fibers or yarns are knitted or woven into a raw or un-dyed fabric. The raw fabric is subsequently dyed. The dyed fabric is then used to make the desired product, such as a garment.

Some common bulk dyeing methods include vat dyeing, beam dyeing, jet dyeing, and bath dyeing. Vat dyeing typically consists of immersing a piece of fabric in a vat of liquid dye. Beam dyeing involves winding a length of fabric about a perforated beam. The beam is then placed in a vessel where liquid dye is pumped into the center of the beam, out of the perforations, and through the fabric. Jet dyeing involves placing the fabric in a high-pressure, high-temperature kettle of liquid dye. Bath dyeing involves immersing the fabric in a bath of dye, which is contained in a rotating drum.

One problem associated with bulk dyeing methods relates to the fabric that is cut away or removed during manufacture of the fabric into the desired garment. Here, the fabric that is cut away has been dyed and, thus, includes the cost of the dye. This can lead to an increased cost of goods for garments made from bulk dyed fabrics. Another problem with bulk dyeing methods relates to the large amounts of water required during processing, which can increase cost of goods for such bulk dyed fabrics.

Yet another problem with bulk dyed fabrics in the manufacture of garments is related to the unpredictability of consumer color preferences. In the garment industry, change in the consumer's preference for one color over another color can lead to an overstock of the undesired colored garments and a back order situation of the desired colored garments. Thus, garments made from bulk dyed fabrics have not proven flexible enough to meet increasing and changing consumer demands.

Further methods of dyeing fabrics involve printing a dye onto a surface of a fabric. This method is commonly used to apply a decorative pattern on the surface of the fabric. Such printing methods include screen-printing and inkjet printing. While these methods have proven useful in quickly changing from one decorative pattern to another, they have not proven useful in bulk dyeing of fabrics or in the dyeing of completed garments.

Accordingly, there is a continuing need for flexible, low cost, low waste methods of dyeing fabrics. Further, there is a continuing need for flexible, low cost, low waste methods of dyeing garments made from fabrics.

### SUMMARY OF THE INVENTION

It is an object of the present invention to provide a former that is configured to allow garments disposed thereon to be sprayed with dye from the exterior of the garment, the interior of the garment, or any combination thereof.

It is another object of the present invention to provide a former that pulls a garment taut and, thus, removes folds and creases from the garment and places the garment in an acceptable condition for spray dyeing.

It is still another object of the present invention to provide a former that mitigates the formation of condensation between the former and any garment thereon.

It is yet another object of the present invention to provide a former that mitigates sprayed dye from bouncing off the garment.

It is a further object of the present invention to provide a former that allows dye sprayed onto a garment to pass through the garment.

It is still a further object of the present invention to provide a former that is made of a two or three dimensional frame. In some embodiments, the frame has a thermal conductivity that is equal to or less than the thermal conductivity of a garment placed thereon.

A former for spraying a garment with a dye is provided. In some embodiments, the former includes a hollow frame having a plurality of individual elements configured to support the garment and a plurality of openings being defined between the plurality of individual elements so that the hollow frame has a thermal conductivity that is equal to or less than a thermal conductivity of the garment.

In other embodiments, the former includes a first hollow tube and a second hollow tube. The first and second hollow tubes are moveable with respect to one another between an outer position and an inner position. The inner position is smaller than an opening of the garment and the outer position is sufficient so that the first and second hollow tubes support the garment thereon.

A process for spraying a dye on a garment is also provided. The process includes placing a first side of the garment on a former having a thermal conductivity that is equal to or less than a thermal conductivity of the garment; spraying a dye on a second side of the garment; and steaming the garment after spraying the dye on the second side but prior to the dye drying on the second side so that the dye migrates from the second side to the first side and reacts with and affixes to a component of the garment.

The above-described and other features and advantages of the present invention will be appreciated and understood by those skilled in the art from the following detailed description, and drawings.

### BRIEF DESCRIPTION OF THE DRAWINGS

FIG. 1 is a perspective view of a garment undergoing a spray dyeing operation according to an exemplary embodiment of the present invention;

FIG. 2 is a schematic illustration of an automated process for manufacturing the garment in FIG. 1;

FIG. 3 is a perspective view of a first exemplary embodiment of a garment former for use with the spray dyeing operation of FIG. 1 and/or the automated process of FIG. 2;

FIG. 4 is a view of the garment former of FIG. 3 having its arms removed;

FIG. 5 is a perspective view of a second exemplary embodiment of a garment former according to the present invention;

FIG. 6 illustrates the garment former of FIG. 5 having a garment thereon;

FIG. 7 is a perspective view of a third exemplary embodiment of a garment former according to the present invention;

FIG. 8 is a perspective view of a fourth exemplary embodiment of a garment former according to the present invention;

FIG. 9 is a perspective view of a fifth exemplary embodiment of a garment former according to the present invention;

FIG. 10 is a schematic illustration of a sixth exemplary embodiment of a garment former according to the present invention; and

FIG. 11 is a sectional view of the former of FIG. 10 taken along lines 11-11.

### DETAILED DESCRIPTION OF THE INVENTION

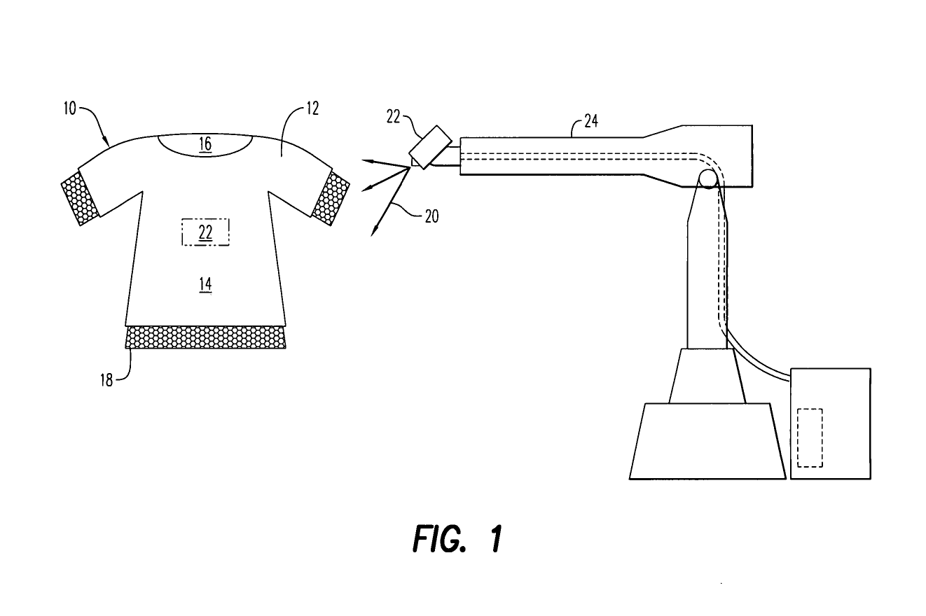

Referring to the drawings and in particular to FIG. 1, a garment generally referred to by reference numeral 10 is shown. For purposes of clarity, garment 10 is illustrated as a shirt. Of course, it is contemplated by the present invention that garment 10 be any garment such as, but not limited to, a brassiere, a pair of pants, a pair of underwear, a pair of panties, a sock, a skirt, a dress, a pair of shorts, a coat, a suit, a scarf, a glove, a hat, and other apparel items.

Garment 10 can be made using traditional cut-and-sew methods. Further, and in lieu of sewing, garment 10 can be made using adhesives, thermal bonding, and other joining methods. Alternately, garment 10 can be made using any machinery, including a circular-knitting machine. Of course, it is contemplated by the present invention for garment 10 to be made by combinations of any of the above methods. Thus, garment 10 can be made of fabric that can have a tubular or body shaped fabric and/or a wide good fabric.

Garment 10 can be made of fabric 12 that is griege or untreated or raw fabric, a bleached fabric, a treated fabric, or any combinations thereof.

Garment 10 has a first or exterior side 14 and a second or interior side 16. Garment 10 is positioned on a former 18 so that first side 14 is substantially exposed. Former 18 provides shape to garment 10 thereby removing folds and creases from the garment.

A dye 20 is sprayed on first side 14 of garment 10 using a spray nozzle 22. Preferably, spray nozzle 22 is movable with respect to first side 14 by, for example, a robot 24. Robot 24 and/or spray nozzle 22 move the spray nozzle with respect to first side 14 so that a substantially even coat of dye 20 is applied to the first side of garment 10.

Spray pressure and/or time may vary depending on the processing criteria, garment type, and garment features such as, but not limited to, bands, buttons, and fasteners.

Advantageously, nozzle 22 can apply dye 20 to first side 14 of garment 10 in about one to about twenty seconds, and preferably in about four to about ten seconds. Of course, this time depends on the size of garment 10, where larger garments would be expected to take longer time and smaller garments would be expected to take shorter time than the aforementioned ranges. In addition, robot 24 can move nozzle to ensure that dye 20 is only applied to first side 14 and, thus, minimizes the use of the dye. Accordingly, the use of dye 20 can be minimized as compared to prior bulk or yarn dyeing methods and the amount of the dye used to manufacture garment 10 can be optimized, which can reduce the cost of the garment.

Former 18 has only as much surface area or structure as is needed to ensure the structural integrity of the former, but as much absent or hollow surface area to minimize contact surface between the former and the garment, which minimizes the formation of condensation and the bounce off of dye and provides the ability to spray through the garment and/or from within the garment.

In a preferred embodiment, former 18 has a hollow interior and a plurality of openings defined therethrough to allow a second nozzle 22 (shown in phantom) to spray second side 16 of garment 10 from the interior of the former. The second nozzle can be stationary with respect to former 18 or can be moved by a second robot within the former.

It should be recognized that the present invention is illustrated in FIG. 1 having one external spray nozzle 22 moved by one robot 24. However, it is also contemplated by the present invention to have more than one robot 24 and/or for the robot to have more than one spray nozzle 22. Moreover, it is also contemplated by the present invention for spray nozzle 22 to remain stationary and for former 18 to be moved with respect to the spray nozzle. Additionally, it is contemplated for both former 18 and nozzle 22 to be moved with respect to one another.

Dye 20 reacts with and affixes to a component of fabric 12. The term “reactive” or “reacts” as used herein shall mean the action of the dye with the fabric that results in the formation of an attachment to the one or more components of the fabric, wherein the attachment can be a covalent bond, an ionic bond, a disbursement into the fiber molecule, or any combination of the foregoing.

For example, fabric 12 can be a polyamide fabric with or without an elastic yarn, including elastane, lycra, nylon, spandex, or any combinations thereof. Dye 20 can be a dye as in U.S. Pat. No. 4,786,721, U.S. Patent Application 2002/0138922A1, European Patent Application No. EP 1 275 700, and other dyes.

In a preferred embodiment, fabric 12 is a synthetic polyamide fabric and dye 20 is a water-soluble dye that reacts with and affixes to an amine site of the fabric so that the dye can bind with the fabric. The reaction of dye 20 with the amine sites of fabric 12 affixes the dye to the fabric through the formation of a covalent bond. It has been found that dye 20 provides a degree of fixation to and penetration into the individual fibers of fabric 12. This fixation of dye 20 to fabric 12 is sufficient to allow the dye to be sprayed on only first side 14 of garment 10, while providing acceptable color at second side 16. It has further been determined that spraying of dye 20 of the present invention allows garment 10 to be manufactured in an automated fashion.

Fabric 12 is described above by way of example as a synthetic polyamide fabric. Additionally, dye 20 is described above by way of example reacting with an amine site of the synthetic fabric. However, it is contemplated by the present invention for fabric 12 to be made of any natural fiber, any synthetic fiber, or any combination thereof. Similarly, it is contemplated by the present invention for dye 20 to be any fiber-reactive compound. For example, dye 20 can be a dye capable of reacting with and/or chemically bonding to the hydroxyl groups of cellulose fibers (e.g., cotton), the amino, carboxy, hydroxy and/or thiol groups of wool or silk fibers, and/or the amino groups and/or carboxy groups of synthetic polyamides.

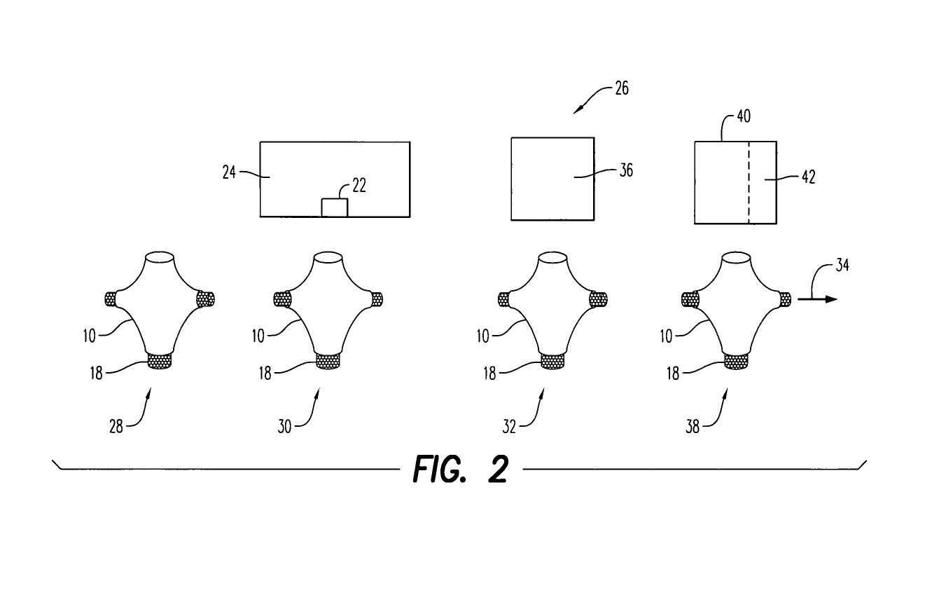

An automated process 26 for manufacturing garment 10 is illustrated in FIG. 2. Process 26 has a first station 28, a second station 30, and a third station 32. Former 18 is, preferably, movable among the first, second, and third stations 28, 30, 32 in a machine direction 34. Alternately, it is contemplated for stations 28, 30, 32 to move with respect to former 18 in a direction opposite direction 34. Further, it is contemplated for stations 28, 30, 32 and former 18 to move with respect to one another.

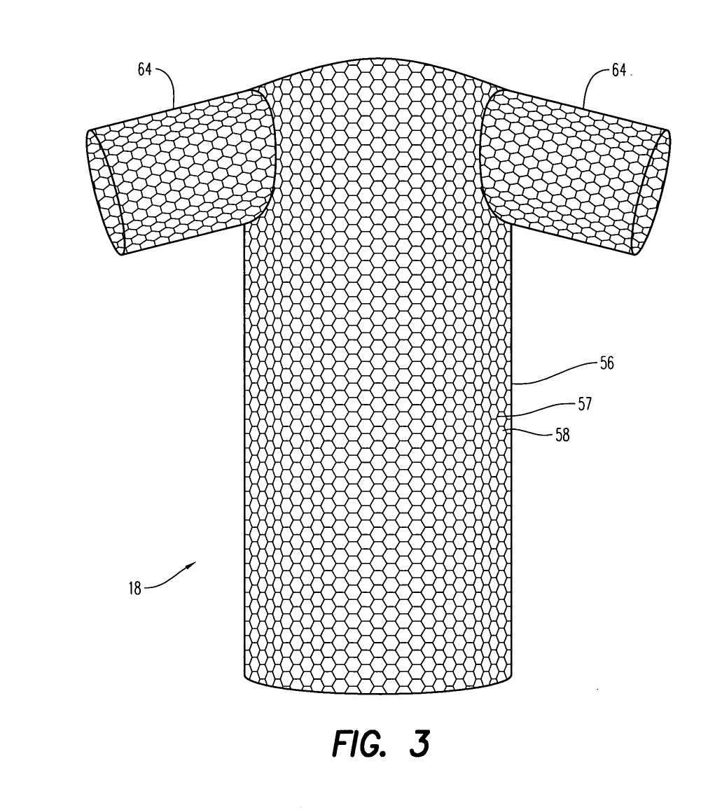

At first station 28, folds are removed from fabric 12. For example, first station 28 positions garment 10 on former 18 so that second side 16 is facing the former and first side 14 is facing away from the former. In this position, former 18 ensures that garment 10 is taut so that any folds or creases in fabric 12 are substantially removed. Thus, first side 14 and/or second side 16 are substantially or entirely exposed. The operation of former 18 will be described in detail herein below with respect to FIG. 3.

Former 18 is exposed to second station 30 where first side 14 is sprayed with the dye. This is preferably achieved by controlling robot 24 to move nozzle 22 with respect to former 18 to spray first side 14 with dye 20. For purposes of clarity, nozzle 22 and robot 24 are illustrated schematically in FIG. 2.

It is also contemplated by the present invention for second station 30 to spray second side 16 with dye 20. This is preferably achieved by controlling a second spray nozzle 22 internal to former 18 to spray second side 16 with dye 20.

Before dye 20 dries on fabric 12, former 18 is exposed to third station 32. Third station 32 spreads dye 20 throughout fabric 12 and affixes the dye to the fabric. For example, third station 32 can apply a desired amount of steam and heat to garment 10. It is believed that the action of steam and heat applied by third station 32 has several benefits to the dyeing of garment 10. In an exemplary embodiment, third station 32 can apply steam to the exterior of former 18, the interior of the former, or any combinations thereof. For example, it is contemplated for former 18 to include a device for supplying steam and/or other pressurized gases (e.g., air) from within the former.

For example, third station 32 can assist in relaxing fabric 12, allowing dye 20 to penetrate between the individual fibers of the fabric and ensuring that the dye migrates from first side 14 to second side 16 (i.e., uniform or substantially uniform distribution of dye 20 throughout fabric 12). In addition, third station 32 can assist in allowing dye 20 to penetrate into the individual fibers of fabric 12. Further, third station 32 can be a catalyst to the chemical reaction between dye 20 and the molecular structure (i.e., amine groups) of fabric 12.

Third station 32 can have a steam hood or autoclave 36 that exposes fabric 12 to steam and heat in a manner and amount sufficient to spread dye 20 throughout fabric 12 and affix the dye to the fabric. For example, third station 32 can apply saturated steam, such as steam at a temperature of about 102 degrees Celsius (215 degrees Fahrenheit) and a relative humidity of about 100 percent. Third station 32 can apply steam to fabric 12 for about 1 to 7 minutes, preferably about 3 to 5 minutes.

It should be recognized that the use of atmospheric steam, pressurized steam, and/or superheated steam, and for a period shorter or longer than the aforementioned time range, is also contemplated by the present invention. It is further contemplated by the present invention for any combination of saturated steam, high temperature steam, and dry heat to be utilized at third station 32.

After dye 20 has been spread through and affixed to fabric 12 at third station 32, former 18 can be exposed to a fourth station 38. Fourth station 38 can wash off or remove any unfixed dye 20 from fabric 12 and/or former 18.

Process 26 advantageously minimizes the amount of dye 20 that is washed off garment 10 by fourth station 38. For example, second station 30 optimizes the amount of dye 20 applied to garment 10. Additionally, the reactive nature of dye 20 used by second station 30 further minimizes the amount of the dye that is applied to garment 10. Accordingly, process 26 can minimize the amount of dye 20 that is washed off by fourth station 38, which can further reduce the cost of the garment as compared to other dyeing methods.

In an exemplary embodiment, fourth station 38 can include a spray head 40 for spraying a cleaning liquid, such as water, on fabric 12. Additionally, fourth station 38 can include a drying portion 42 for removing the cleaning liquid and any residual, un-affixed dye from garment 10. In addition, drying portion 42 can dry dye 20. Drying portion 42 can dry garment 10 by way of convection, conduction, pressure, centrifugal forces, or any combinations thereof. Preferably, drying portion 42 exposes garment 10 to convective heat to dry dye 20 on garment 10.

Advantageously, process 26 applies, spreads, and affixes dye 20 in fabric 12, then the process washes and dries the garment, all in a time effective, efficient manner. Process 26 consumes less energy than prior dyeing systems. In addition, process 26 results in less water being used and effluent being discharged into the atmosphere. Accordingly, the cost of garment 10 can be reduced in an environmentally friendly manner.

In addition, process 26 allows for rapid changeover from one color to another color. For example, process 26 can make as few as one garment 10 of a first color before changing over to dye the next garment with a second, different color. Thus, process 26 also eliminates the inventory control costs and problems associated with the pre-dyed yarns and pre-dyed garments of prior processes.

It has also been found that process 26 can be used to separate the manufacture of the garment from the dyeing of the garment. This separation of the garment manufacture from the dyeing of the garment provides several advantages over prior processes. For example, process 26 can be used to provide quicker response time to consumer needs by having a supply of un-dyed garments, which can be readily dyed as needed. In this example, the dyeing of the garments can be delayed until closer to the actual season than previously possible.

It has been determined that the conditions that garment 10 and former 18 are exposed to during process 26 can negatively effect the degree of fixation of dye 20 and penetration of the dye into the individual fibers of fabric 12. Specifically, it has been determined by the present invention that condensation between former 18 and garment 10 can deleteriously effect the fixation and/or migration of dye 20.

For example, third station 32 applies a desired amount of steam and heat to garment 10. In addition, fourth station 38 can add heat to garment 10 during the drying phase. Accordingly, it has been determined that condensation can form in the areas of contact between garment 10 and former 18 (i.e., on second or interior side 16 of the garment) during the application of steam and heat to garment 10.

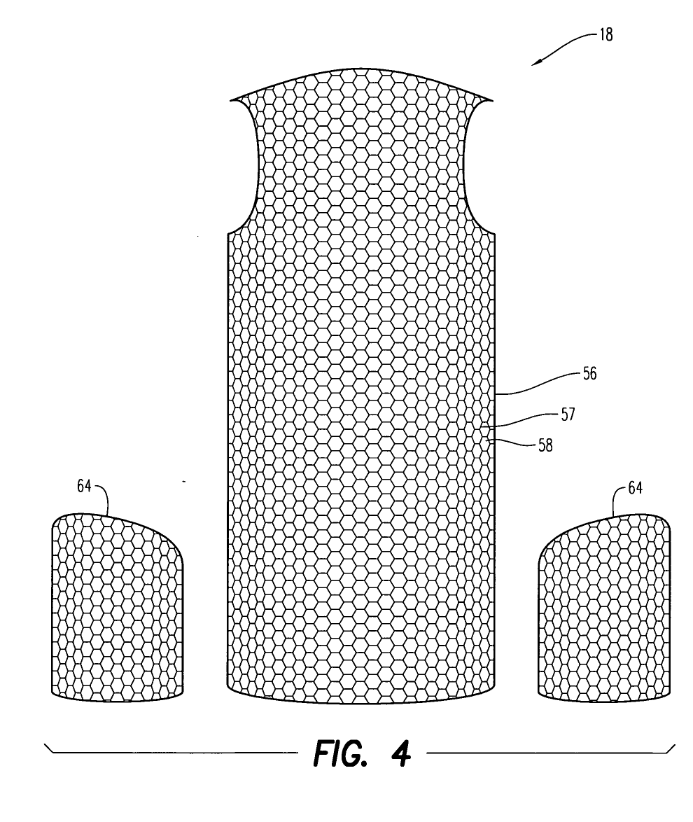

Advantageously, former 18 eliminates and/or mitigates the formation of condensation between garment 10 and former 18. A first exemplary embodiment of former 18 is described with reference to FIGS. 3 and 4. Here, former 18 is shaped for use in the dyeing of t-shirts.

As stated above, former 18 is configured to minimize contact between the former and interior side 16 of garment 10. It has been determined that minimizing contact between former 18 and interior side 16 minimizes the area where condensation can form and, thus, minimizes the area where this condensation can deleteriously effect the fixation and/or migration of dye 20. In order to minimize contact area, former 18 is formed of a three-dimensional hollow frame 56 that defines a plurality of openings 58 between the individual elements of the frame 57. By three-dimensional, it is meant that frame 56, in the example where former 18 is used to dye shirts, approximates the size and shape of a human torso.

Frame 56 is made of materials capable of withstanding the conditions of process 26. For example, frame 56 is made of materials capable of withstanding the temperatures up to about 215 degrees Celsius (420 degrees Fahrenheit). Preferably, frame 56 is made of materials that can not absorb or be stained by dye 20. In this manner, dye sprayed on a first garment is not inadvertently transferred to subsequent garments placed on former 18. In a preferred embodiment, frame 56 is made of metal such as, but not limited to, galvanized steel or stainless steel. Of course, other metallic and non-metallic materials capable of meeting the aforementioned conditions are contemplated by the present invention.

It has also been determined that minimizing contact between former 18 and interior side 16 prevents and/or mitigates dye 20 from bouncing off garment 10. For example, it has been found that spraying of dye 20 on while garment 10 is supported on a rigid surface causes a portion of the dye to bounce off the garment, which requires additional dye to be applied and increases the cost of the dyeing operation. Advantageously, minimizing contact between former 18 and interior side 16 reduces the areas in which garment 10 is supported by a rigid structure and, thus, minimizes the bouncing off of dye from the garment. In addition, it has been found that minimizing contact between former 18 and interior side 16 allows at least a portion of the sprayed dye to pass through garment 10 to the interior side.

In one embodiment of the present invention, former 18 has a thermal conductivity (k1) that is equal to or less than the thermal conductivity (k2) of garment 10. When the thermal conductivity (k1) of former 18 is equal to the thermal conductivity (k2) of garment 10, the former is maintained at substantially the same temperature as the garment during process 26 and, thus, the formation of condensation is prevented and/or minimized.

Moreover, it has been found that ensuring that the thermal conductivity (k1) of former 18 is less than the thermal conductivity (k2) of garment 10, the former reaches the process temperature faster than the garment during process 26 and, thus, any condensation that may occur forms on exterior side 14 of the garment. Advantageously, it has been determined that condensation on exterior side 14 of garment 10 assists dye 20 to spreads throughout fabric 12 and to affix to the fabric.

The hollow nature of former 18, as well as openings 58 of frame 56, reduce the mass of the former and allow the temperature during process 26 to be substantially the same on all sides of the former.

Advantageously, former 18 can accommodate garments of various styles and shapes. For example, former 18 can include a pair of removable arms 64. Arms 64 are shown in FIG. 3 connected to former 18 and in FIG. 4 removed from the former. In this manner, former 18 can be used for the dyeing of various styles of garments such as, but not limited to, sleeveless shirts, tank tops, short sleeve shirts, or long sleeve shirts, by simply matching the shape and length of arms 64 to the garment to be dyed.

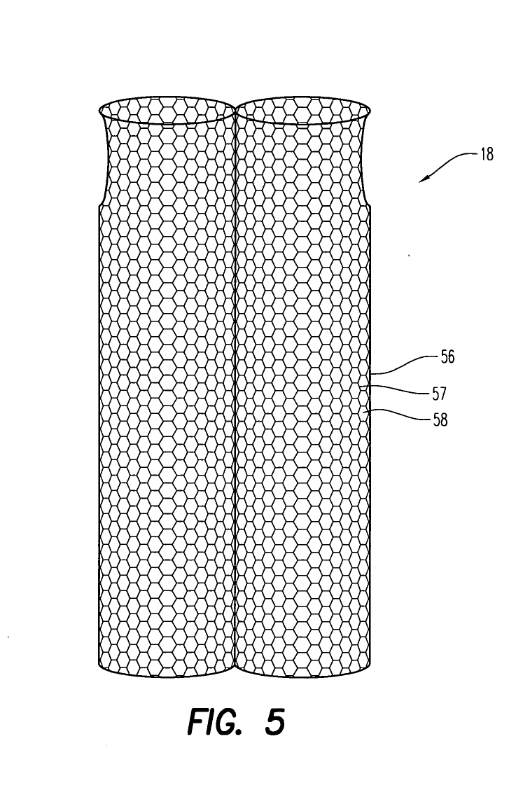

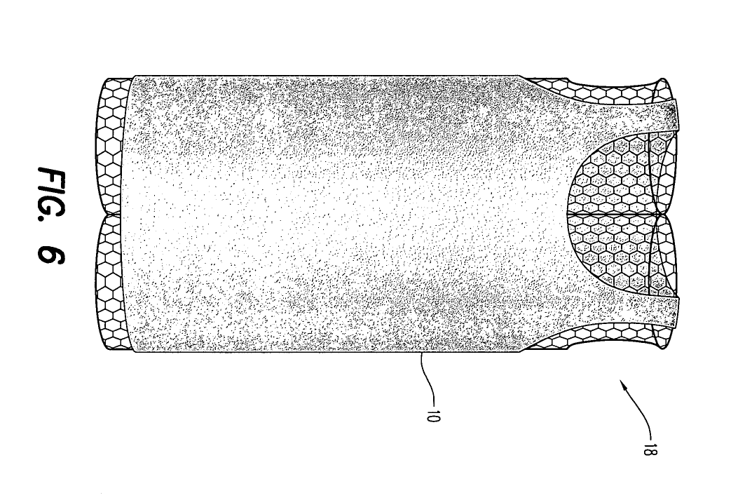

A second exemplary embodiment of former 18 for use in the dyeing of tank tops and sleeveless t-shirts is described with reference to FIGS. 5 and 6. Former 18 is illustrated in FIG. 5 without garment 10, and in FIG. 6 with the garment thereon. Again, former 18 is formed of a three-dimensional hollow frame 56 that defines a plurality of openings 58 between the individual elements to minimize contact between the former and interior side 16 of garment 10.

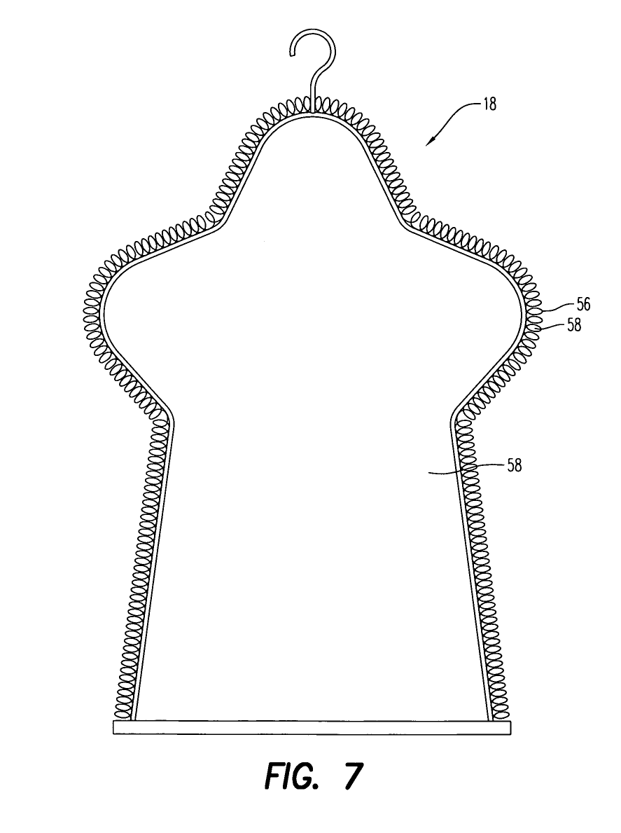

A third exemplary embodiment of former 18 for use in the dyeing of t-shirts is described with reference to FIG. 7. Again, former 18 is configured to minimize contact between the former and interior side 16 of garment 10. In this embodiment, former 18 is formed of a two-dimensional frame 56 that defines a plurality of openings 58 between the individual elements. In this embodiment, garment 10 can only be sprayed from exterior side 14.

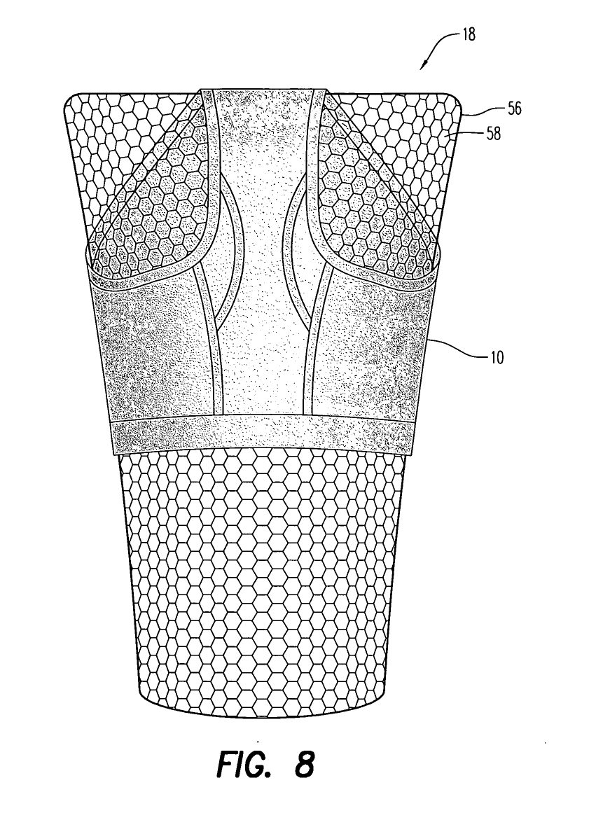

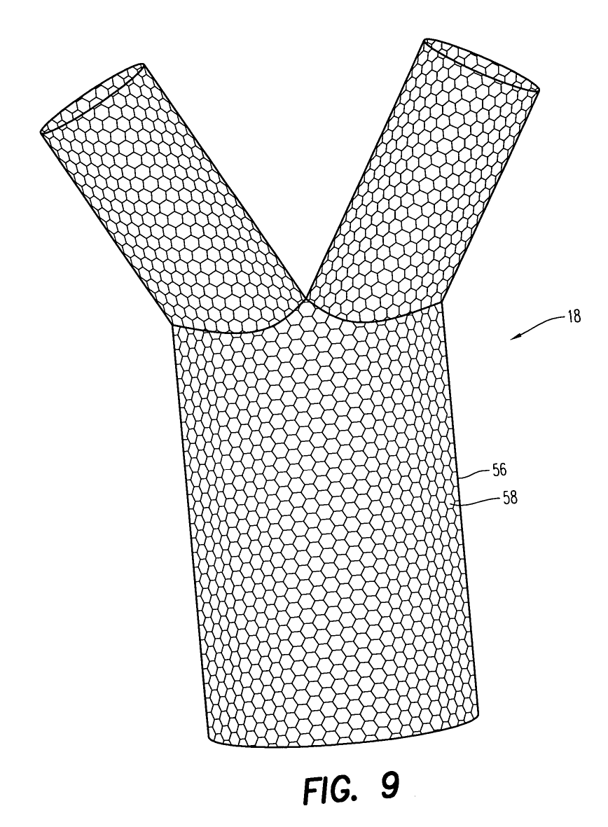

It should be recognized that former 18 is described above by way of example in use with a shirt. Of course, it is contemplated by the present invention for former 18 to find use with other non-shirt garments. For example, former 18 is shown in FIG. 8 configured for use with a pair of briefs and in FIG. 9 configured for use with a pair of shorts (not shown). In these examples, former 18 is formed of three-dimensional hollow frame 56 that defines plurality of openings 58 between the individual elements to minimize contact between the former and interior side 16 of garment 10.

It should be recognized that frame 56 of former 18 is described above by way of example as a stationary frame. However, it is also contemplated by the present invention for frame 56 to be moveable between a first outer dimension and a second outer dimension. First outer dimension can be such that frame 56 can be easily be placed inside a torso opening 54 of garment 10. Once moved to second outer dimension, frame 56 contacts interior side 16 of garment 10, pulling the garment taut and, thus, removing folds and creases from the garment. It is contemplated by the present invention for frame 56 to move or reciprocate in any known manner. For example, frame 56 can be inflated and deflated to move the frame between the first and second outer dimensions.

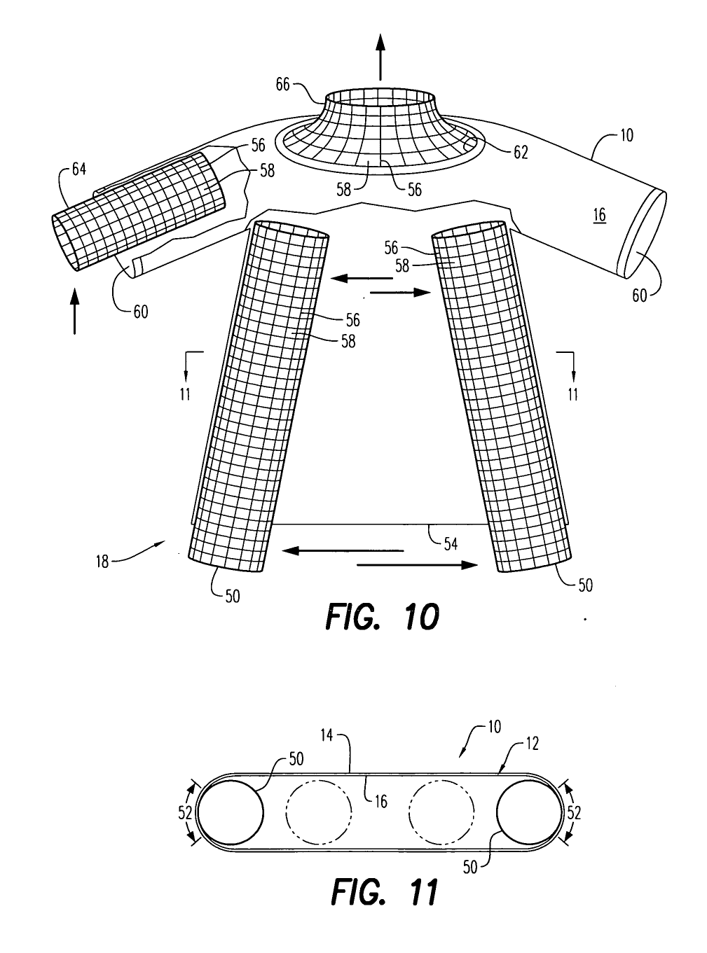

Another exemplary embodiment of a moveable former 18 is described with reference to FIGS. 10 and 11. For purposes of clarity, portions of garment 10 are shown in FIG. 10 cut away to reveal the interaction of former 18 and the garment.

Former 18 includes a plurality of supports 50 configured to minimize contact between the supports and interior side 16 of garment 10. It has been determined that minimizing contact between supports 50 and interior side 16 minimizes the area where condensation can form and, thus, minimizes the area where this condensation can deleteriously effect the fixation and/or migration of dye 20. For example, supports 50 can have a substantially circular cross section so that only a portion 52 of the outer circumference of the supports contacts interior side 16. In a preferred embodiment, supports 50 each have a diameter of about 4 inches and a length of about 44 inches.

It has also been determined that minimizing contact between supports 50 and interior side 16 prevents and/or mitigates dye 20 from bouncing off garment 10. For example, it has been found that spraying of dye 20 on while garment 10 is supported on a rigid surface causes a portion of the dye to bounce off the garment, which requires additional dye to be applied and increases the cost of the dyeing operation. Advantageously, minimizing contact between supports 50 and interior side 16 reduces the areas in which garment 10 is supported by a rigid structure and, thus, minimizes the bouncing off of dye from the garment.

In the illustrated embodiment, former 18 is shown having two supports 50 with circular cross sections. Of course, it is contemplated by the present invention for former 18 to have as many supports 50 as are necessary to maintain garment 10 in the desired taut condition and/or for the supports to have other, non-circular cross sections.

Former 18 moves or reciprocates supports 50 between an outer position (shown in solid lines in FIG. 11) and an inner position (shown in phantom in FIG. 11). In the inner position, supports 50 are spaced from one another so that the supports can easily be placed inside a torso opening 54 of garment 10. Once moved to outer position, supports 50 contact interior side 16 along portion 52, pulling garment 10 taut and, thus, removing folds and creases from the garment. It is contemplated by the present invention for supports 50 to move or reciprocate in any known manner. Former 18 can move supports 50 with respect to one another a preset distance and/or to a preset pressure.

In one embodiment of the present invention, former 18 is configured to ensure that the thermal conductivity (k1) of supports 50 is equal to or less than the thermal conductivity (k2) of garment 10. When the thermal conductivity (k1) of supports 50 is equal to the thermal conductivity (k2) of garment 10, the supports are maintained at substantially the same temperature as garment during process 26 and, thus, the formation of condensation is prevented and/or minimized.

Moreover, it has been found that ensuring that the thermal conductivity (k1) of supports 50 is less than the thermal conductivity (k2) of garment 10, the supports reach the process temperature faster than the garment during process 26 and, thus, any condensation that may occur forms on exterior side 14 of the garment. Advantageously, it has been determined that condensation on exterior side 14 of garment 10 assists dye 20 to spreads throughout fabric 12 and to affix to the fabric.

In an exemplary embodiment, each support 50 is a hollow tube made from a frame 56. Frame 56 defines a plurality of openings 58 between the individual elements. The hollow nature of support 50, as well as the openings 58 of frame 56, reduce the mass of the support and allow the temperature during process 26 to be substantially the same on all sides of the support.

As stated above, frame 56 is made of materials capable of withstanding the conditions of process 26. For example, frame 56 is made of materials capable of withstanding the temperatures up to about 215 degrees Celsius (420 degrees Fahrenheit). Preferably, frame 56 is made of materials that can not absorb or be stained by dye 20. In this manner, dye sprayed on a first garment is not inadvertently transferred to subsequent garments placed on former 18. In a preferred embodiment, frame 56 is made of metal such as, but not limited to, galvanized steel or stainless steel. Of course, other metallic and non-metallic materials capable of meeting the aforementioned conditions are contemplated by the present invention.

As stated above, it has also been determined that openings 58 of supports 50 can further prevent and/or mitigate dye 20 from bouncing off garment 10. Advantageously, supports 50 having openings 58 further reduces the areas in which garment 10 is supported by a rigid structure and, thus, minimizes the bouncing of dye from the garment.

Advantageously, former 18 having reciprocating supports 50 can accommodate garments of various sizes, styles, and shapes. For example, former 18 can accommodate garments of various sizes, styles, and shapes by merely adjusting the distance with which supports 50 move with respect to one another.

As many garments include more than one opening, former 18 can also include a support for each opening of the garment. In the illustrated embodiment of FIG. 16 where garment 10 is a shirt, the garment includes a pair of arm openings 60 and a neck opening 62. Here, former 18 includes an arm support 64 (only one shown) and a neck support 66.

Arm and neck supports 64, 66 are configured much like support 50. Specifically, supports 64, 66 are configured to be moved into and out of contact with interior side 16 of garment 10. Further, supports 64, 66 are a hollow structures made from frame 56 to define openings 58 therein.

Thus, supports 64, 66 minimize contact between the supports and interior side 16 of garment 10 to minimize areas for condensation to form and and/or mitigates dye 20 from bouncing off garment 10. Supports 64, 66 also have a thermal conductivity (k3) that is equal to or less than the thermal conductivity (k2) of garment 10 to ensure that the formation of condensation is prevented and/or minimized.

However, it has been determined that certain garment openings, such as arm and neck openings 60, 62, may only need one support to ensure that fabric 12 is taut. For example, arm and neck supports 64, 66 of the illustrated embodiment act similar to a hanger. Here, gravity and/or an upward movement of arm and neck supports 64, 66 can be used to remove folds and creases from garment 10. Of course, it is contemplated by the present invention for arm support 64 and/or neck support 66 to include two or more supports that move with respect to one another in the manner described above with respect to supports 50.

As described herein, former 18 minimizes contact with garment 10 to reduce the surface area for condensation to gather and reduce dye bounce off, allows sprayed dye to pass through the garment, minimizes the formation of condensation by material selection and configuration of the former, and/or ensures that any condensation that may form does so on the outer surface of the garment. Thus, former 18 eliminates or mitigates many of the deleterious effects that can occur during spray dyeing due to condensation and ensures that any condensation that may occur is complementary to the spray dyeing process. Further, former 18 eliminates or mitigates many of the deleterious effects that can occur during spray dyeing of garments on a rigid surface.

It should be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present invention not be limited to the particular embodiment(s) disclosed as the best mode contemplated for carrying out this invention, but that this invention will include all embodiments falling within the scope of the present disclosure.

1. A former for spraying a garment with a dye, comprising:
a hollow frame having a plurality of individual elements configured to support the garment thereon; and
a plurality of openings being defined between said plurality of individual elements so that said hollow frame has a thermal conductivity that is equal to or less than a thermal conductivity of the garment.

2. The former as in claim 1, wherein said hollow frame comprises a two or three-dimensional shape.

3. The former as in claim 1, wherein said hollow frame comprises a material that can not absorb or be stained by the dye.

4. The former as in claim 1, wherein said hollow frame comprises galvanized steel or stainless steel.

5. The former as in claim 1, wherein said hollow frame is moveable between a first outer dimension and a second outer dimension, said first outer dimension being smaller than an opening of the garment and said second outer dimension being sufficient so that said hollow frame contacts an interior side of the garment.

6. The former as in claim 1, further comprising a second hollow frame, said hollow frame and said second hollow frame being moveable with respect to one another between an outer position and an inner position, said outer position being smaller than an opening of the garment and said inner position being sufficient so that said hollow frame and said second hollow frame contact an interior side of the garment.

7. A former for spraying a garment with a dye, comprising:
a first hollow tube; and
a second hollow tube, said first and second hollow tubes being moveable with respect to one another between an outer position and an inner position, said inner position being smaller than an opening of the garment and said outer position being sufficient so that said first and second hollow tubes support the garment thereon.

8. The former as in claim 7, wherein said first and second tubes contact an interior side of the garment and remove folds and creases from the garment when in said outer position.

9. The former as in claim 8, wherein said first and second hollow tubes comprise a substantially circular cross section so that only a portion of an outer circumference of said first and second hollow tubes contact said interior side of the garment in said outer position.

10. The former as in claim 8, wherein said first and second hollow tubes each have a diameter of about 4 inches.

11. The former as in claim 7, wherein said first and second hollow tubes comprise a material that can not absorb or be stained by the dye.

12. The former as in claim 7, wherein said first and second hollow tubes each have a thermal conductivity that is equal to or less than the thermal conductivity of the garment.

13. The former as in claim 7, wherein said first and second hollow tubes each comprises a hollow frame having a plurality of openings defined therein.

14. A process for spraying a dye on a garment, comprising:
placing a first side of the garment on a former having a thermal conductivity that is equal to or less than a thermal conductivity of the garment;
spraying a dye on a second side of the garment; and
steaming the garment after spraying said dye on said second side but prior to said dye drying on said second side so that said dye migrates from said second side to said first side and reacts with and affixes to a component of the garment.

15. The process as in claim 14, wherein placing said first side on said former further comprises removing folds and creases from the garment.

16. The process as in claim 14, further comprising defining a plurality of openings in said former to minimize contact between said former and said first side.

17. The process as in claim 16, further comprising spraying said dye through said plurality of openings on said first side of the garment before exposing the garment to said migration and fixation process.

18. The process as in claim 16, wherein said plurality of openings allow at least a portion of the sprayed dye to pass through the garment from said second side to said first side.

19. The process as in claim 14, wherein said reaction and affixation between said dye and said component forms an attachment selected from the group consisting of a covalent bond, an ionic bond, a disbursement into the fiber molecule, and any combinations of the foregoing.

20. The process as in claim 14, wherein said dye has a substantially uniform distribution throughout the garment after said steaming.

21. The process as in claim 14, wherein placing said first side on said former comprises:
moving said former to a first outer dimension that is smaller than an opening of the garment;
placing said first side on said former; and
moving said former to a second outer dimension that is sufficient to remove folds and creases from the garment.

22. The process as in claim 14, wherein said former comprises a pair of hollow tubes moveable with respect to one another between an outer position and an inner position and wherein placing said first side on said former comprises:
moving said pair of hollow tubes to said inner position, said inner position being smaller than an opening of the garment;
placing said first side on said first and second tubes; and
moving said first and second tubes to said outer position, said outer position being sufficient to remove folds and creases from the garment.
